(19) United States
(12) Patent Application Publication
(10) Pub. No.: US 2026/0340000 A1
(43) Pub. Date: Oct. 29, 2026

(54) HYBRID CAG/RAG WORKFLOW

(71) Applicant: CrowdStrike, Inc., Sunnyvale, CA (US)

(72) Inventors: Calin-Bogdan Miron, Domnesti (RO); Sandra Servia Rodriguez, Cambridge (GB); Andrew Southgate, Cambridge (GB); Ionut Catalin Sandu, Bucuresti (RO)

(21) Appl. No.: 19/188,866

(22) Filed: Apr. 24, 2025

(51) Int. Cl. G06F 16/3331; G06N 3/042; G06N 3/0475

(52) U.S. Cl. CPC G06F 16/3331; G06N 3/042; G06N 3/0475

(57) ABSTRACT

A hybrid cache-augmented generation (CAG)/retrieval-augmented generation (RAG) workflow for an Artificial Intelligence (AI) is described herein. The workflow includes preloading a CAG context of a large language model (LLM) of the AI based on predefined relevance criteria. In some examples, the predefined relevance criteria may be the queries most frequently received by the AI and the CA G context may be preloaded with information relevant to answering those queries. The workflow further includes receiving a query and first utilizing a CAG technique to attempt to answer the query based the CAG context and LLM. If results of the CAG technique do not meet a success criterion, the workflow then utilizes a RAG technique to retrieve information from external source(s). In some examples, the workflow may determine whether the query is included among the most frequent queries, performing the CAG technique if it is, and the RAG technique if it isn't.

### BACKGROUND

Modern artificial intelligence (AI) systems often face challenges in handling tasks that require both static and dynamic knowledge integration. One solution to these challenges is cache-augmented generation (CAG). CAG works by preloading knowledge into the context window of a long context (LC) large language model (LLM) and excels in scenarios with static, pre-curated knowledge bases. An alternative solution, retrieval-augmented generation (RAG) can dynamically fetch information from external sources.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 shows a hybrid cache-augmented generation (CA G)/retrieval-augmented generation (RAG) workflow for an artificial intelligence (AI) that preloads a CAG context based on predefined relevance criteria, attempts to answer a query using a CAG technique, and falls back to a RAG technique when the result of the CAG technique does not meet a success criterion.

FIG. 2 shows a hybrid CAG/RAG workflow for an AI that preloads a CAG context based on most frequent queries received by the AI, determines if a query is included among the most frequent queries, utilizes a CAG technique when the query is among the most frequent queries, and utilizes a RAG technique when the query is not among the most frequent queries.

FIG. 3 shows an update to the most frequent queries received by an AI and a corresponding refresh of the knowledge items stored in a CAG context, the knowledge items being information relevant to answering the most frequent queries.

FIG. 4 shows a flowchart of an example process for preloading a CAG context based on predefined relevance criteria, attempting to answer a query using a CAG technique, and falling back to a RAG technique when the result of the CAG technique does not meet a success criterion.

FIG. 5 shows a flowchart of an example process for preloading a CAG context based on most frequent queries received by the AI, determining if a query is included among the most frequent queries, utilizing a CAG technique when the query is among the most frequent queries, and utilizing a RAG technique when the query is not among the most frequent queries.

FIG. 6 shows an example system architecture for a computing device that is capable of implementing the hybrid CAG/RAG workflow for an AI.

### DETAILED DESCRIPTION

Cache-augmented generation (CAG) struggles to handle queries that rely on real-time or dynamic knowledge updates and may be cost-prohibitive when the preloaded content is very large. Retrieval-augmented generation (RAG), however, introduces latency, complexity, and potential retrieval errors. This disclosure is directed in part to a hybrid CAG/RAG workflow for an Artificial Intelligence (AI). The workflow (performed by, e.g., a “workflow component”) may include preloading a CAG context of a large language model (LLM) of the AI based on predefined relevance criteria. In some examples, the predefined relevance criteria may be the queries most frequently received by the AI and the CAG context may be preloaded with information relevant to answering those queries. The workflow may further include receiving a query and first utilizing a CAG technique to attempt to answer the query based the CAG context and LLM. If results of the CAG technique do not meet a success criterion, the workflow may then utilize a RAG technique to retrieve information from external source(s). In some examples, the workflow may determine whether the query is included among the most frequent queries, performing the CAG technique if it is, and the RAG technique if it isn't. In some examples, part of a query may appear among the most frequent queries, and part may not-in such circumstances, the workflow may include performing a CAG technique for the part included among the most frequent queries and a RAG technique for the part not included.

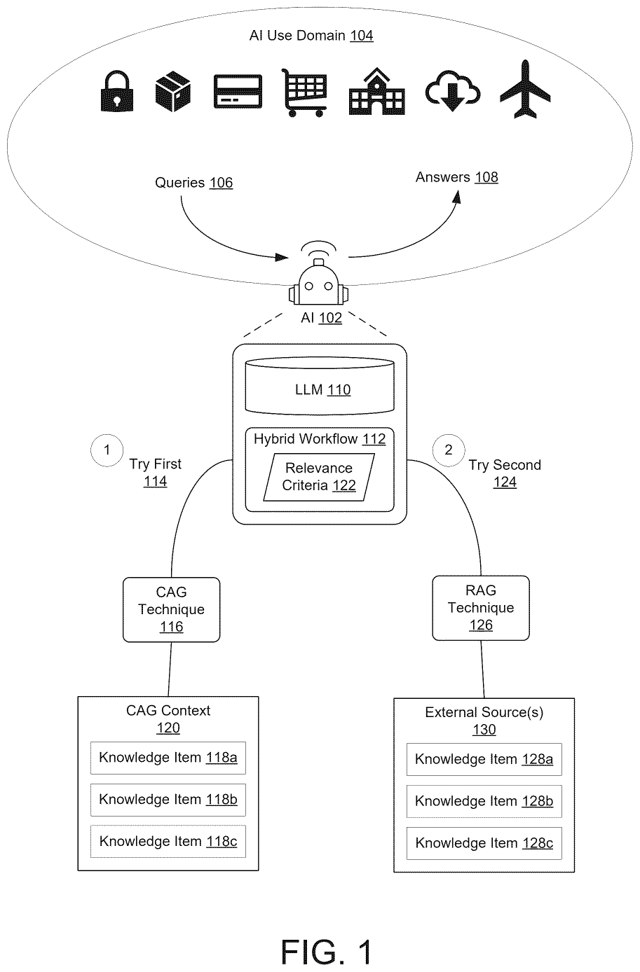

FIG. 1 shows a hybrid cache-augmented generation (CAG)/retrieval-augmented generation (RAG) workflow for an artificial intelligence (AI) that preloads a CAG context based on predefined relevance criteria, attempts to answer a query using a CAG technique, and falls back to a RAG technique when the result of the CAG technique does not meet a success criterion. As illustrated, an AI 102 may serve any sort of AI use domain 104, receiving queries 106 from users and devices in an AI use domain 104 and providing answers 108 to those queries 106 based at least on LLM 110. The AI 102 may also utilize a hybrid CAG/RAG workflow 112 (which may be an example of a “workflow” or “workflow component”) with the LLM 110 in determining answers 108 to the queries 106. The hybrid CAG/RAG workflow112 may first try, at 114, a CAG technique 116 to attempt to answer a query 106. The CAG technique 116 may include knowledge items 118 from a CAG context 120 of the LLM 110 with a prompt based on the query 106 to evaluate with the LLM 110. The information stored as the knowledge items 118 may be based on predefined relevance criteria 122. If the attempt to answer the query 106 using the CAG technique 116 does not meet a success criterion, the hybrid CAG/RAG workflow 112 may try, at 124, a RAG technique 126. The RAG technique 126 may involve retrieving knowledge items 128 from external source(s) 130 and integrates the knowledge items 128 with a prompt based on the query 106 to evaluate with the LLM 110. Evaluation of the knowledge items 118 or knowledge items 128 with the prompt by the LLM 110 may produce the answer 108. Additionally, FIG. 1 shows knowledge items 118 as knowledge items 118a, 118b, and 118c simply to indicate that the knowledge items 204 may comprise multiple, different items of information. FIG. 1 shows knowledge items 128 as knowledge items 128a, 128b, and 128c simply to indicate that the knowledge items 128 may comprise multiple, different items of information.

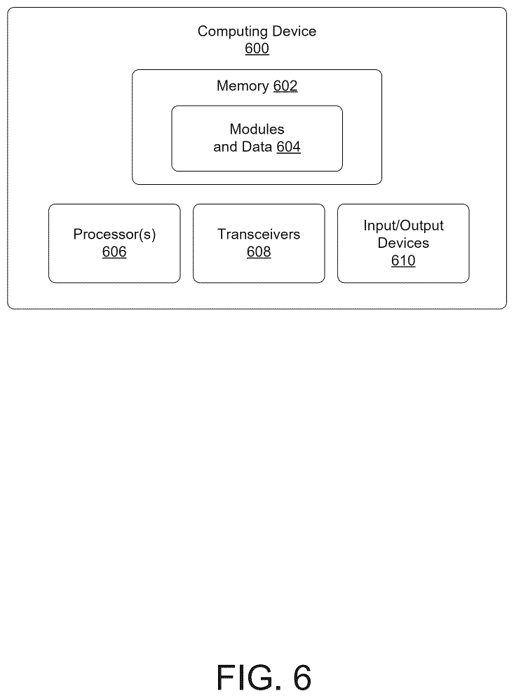

No computing device is illustrated in FIG. 1. It is to be understood, however, that components such as the AI 102, including the hybrid CAG/RAG workflow 112, may be implemented by one or more computing devices. The one or more computing device(s) may be physical computing device(s) or a virtual computing device(s) (also referred to herein as “virtual machines”). For example, the one or more computing device(s) may each be a computer, a workstation, a mobile computing device, an Internet of Things (IoT) device, a server, a cloud computing resource, a virtual computing element such as a container, a network element such as a gateway or a firewall, and/or any other type of computing device or computing system. An example computing device capable of serving as one of the one or more computing device(s) is illustrated in FIG. 6 and described further herein with reference to that figure.

The computing device(s) may be connected by any sort of public or private network with each other and/or with other computing devices. The various devices of the network may be connected by wired mechanisms, wireless mechanisms, or both. The network may also allow access to an external network, such as the Internet, through gateway or firewall devices that provide access controls for incoming connections. Access to the external source(s) 130, for example, may be through the network.

In various implementations, the AI use domains 104 may include any field or purpose in which AI, such as AI 102, could be used. FIG. 1 shows icons for cybersecurity (a lock), shipping (a box), payments (a credit card), ecommerce (a shopping cart), education (a school), cloud services (a cloud), and travel (an airplane). These are just a few examples of the vast number of AI use domains 104 in which AI can be used. AI 102 may, however, be particular to a specific AI use domain 104 or subset of AI use domains 104, receiving queries 106 from users and devices in that/those AI use domain(s) 104 and providing answers 108 in response.

The queries 106 may be received as natural language questions or requests or as structured language (e.g., structured query language (SQL)) representations of the questions or requests. In some implementations, the AI 102, upon receiving natural language questions or requests, may generate structure language representations of those questions or requests. Both the received queries 106 and any representations generated of them are referred to herein as “queries 106”. These queries 106 may become at least a part of the prompt(s) for processing by the LLM 110. The answers 108 may be provided back in a same form as the queries 106 were received or in any form which the AI 102 is configured to provide (e.g., graphic, natural language, structured language, etc.).

In various implementations, the AI 102 may be an instance of an AI agent asked to play a role and have a purpose associated with the specific AI use domain(s) 104. The role and purpose may inform system prompt(s) of the AI 102. Along with the system prompt(s) and task prompt(s), the AI 102 has the LLM 110, which may be an LLM of an entity operating the computing device(s) and network and which may be trained on data of the entity. For example, if the entity is a cybersecurity service provider, the LLM 110 may be trained on cybersecurity data to identify vulnerabilities, threats, and exploits.

In some implementations, the system prompt(s) formed by the role and purpose may establish the context in which the LLM 110 forms its responses. The task prompt(s) may tell the LLM 110 specifically what to do, providing the LLM 110 with additional capabilities. In addition to the prompts and LLM 110, the AI 102 may also rely on available tools. The available tools may be parametrized functions that perform simple tasks (e.g., file reading, directory traversal, command execution, etc.) and the LLM 110 may decide which tools to use and which parameters to be called with those tools.

Further, the LLM 110 may be a long context (LC) LLM with an extended cache for storing relatively static information to use in supplementing the prompts based on queries 106. This extended cache is shown in FIG. 1 as CAG context 120 and is referred to herein throughout as “CAG context” or “CAG context 120.” The CAG context 120 may be memory associated with the LLM 110 of a fixed size and may be cleared or updated from time to time.

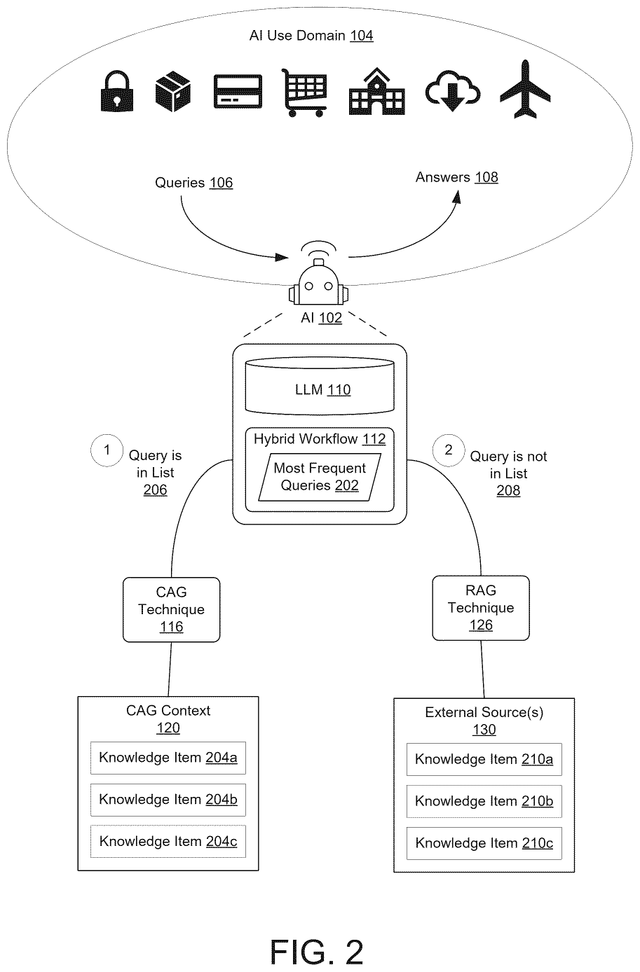

As illustrated in FIG. 1, the AI 102 includes and utilizes both the LLM 110 and a hybrid CAG/RAG workflow 112. While the hybrid CAG/RAG workflow 112 is shown as a component of the AI 102, it is to be understood that it may instead be a separate but associated component used by the AI 102. The hybrid CAG/RAG workflow 112 may be configured to use CAG techniques 116, RAG techniques 126, and to orchestrate order and conditions of using the CAG techniques 116 and/or RAG techniques 126. The hybrid CAG/RAG workflow 112 may also store or specify predefined relevance criteria 122 to determine which information to store in the CAG context 120. The predefined relevance criteria 122 may be most frequently received queries 106 (an example illustrated in FIG. 2), information identified for a future LLM update, etc.

In various implementations, the hybrid CAG/RAG workflow 112 may include management of the CAG context 120, determining which knowledge items 118 are stored in the CAG context 120 and updating it from time to time based on the predefined relevance criteria 122. The updating may be automatic or conditional-for example, if there has been no change to the predefined relevance criteria 122 or to the information identified by those predefined relevance criteria 122, there may be no change to the knowledge items 118 that needs to be made. In such examples, the hybrid CAG/RAG workflow 112 may forego the update. In other examples, if the information identified by the predefined relevance criteria 122 has been updated, or if the predefined relevance criteria themselves have been updated, the hybrid CAG/RAG workflow 112 may update the knowledge items 118 based on such changes. Each knowledge item 118 may represent some discrete part or instance of the information identified by the predefined relevance criteria 122. The timing of updates may be driven be a set update period or by changes to the predefined relevance criteria 122 or information identified by the predefined relevance criteria 122.

In some examples, the hybrid CAG/RAG workflow 112 may process the knowledge items 118 to generate a key-value cache for the knowledge items 118 and may preload the key-value cache for the knowledge items 118 into the CAG context 120.

The hybrid CAG/RAG workflow 112 may be invoked for each received query 106 or may be invoked on a case-by-case basis by the AI 102 based on needs of the LLM 110. For example, the AI 102 may first attempt to answer the query 106 without reference to information from the hybrid CAG/RAG workflow 112 and, if the answer produced by the LLM 110 does not meet a success criterion, the AI 102 may invoke the hybrid CAG/RAG workflow 112. The success criterion may be any sort of criterion utilized by an AI 102 in evaluating whether an answer is satisfactory, such as user responses/ratings, consistency with other available information, etc. Alternatively, the AI 102 may apply some criterion in determining whether to invoke the hybrid CAG/RAG workflow 112 or simply proceed without doing so.

In some implementations, when the hybrid CA G/RA G workflow 112 is invoked by the AI 102, the hybrid CAG/RAG workflow 112 may first try, at 114, to utilize a CAG technique 116. The CAG technique 116 may include retrieving some or all of the knowledge items 118 from the CAG context 120 and integrating the retrieved knowledge items 118 with the prompt derived from the query 106 for processing by the AI 102. Such processing may include submitting the prompt with the integrated knowledge items 118 to the LLM 110 to attempt to answer the query 106. The result of the processing by the LLM 110 may then be compared with a success criterion. If the success criterion is met, the AI 102 may provide the answer 108 based on the results from the LLM 110, with no further work to be done by the hybrid CAG/RAG workflow 112.

When the success criterion is not met, however, the hybrid CAG/RAG workflow 112 may next try, at 124, to utilize a RAG technique 126. The RAG technique 126 may include retrieving knowledge items 128 from external sources 130 and integrating the retrieved knowledge items 128 with the prompt derived from the query 106 for processing by the AI 102. The RAG technique 126 may utilize a retrieval model, such as an information retrieval component, that takes the query 106 or information derived from the query 106 as input in retrieving the knowledge items 128 from external sources 130. In some examples, before integrating the knowledge items 128 with the prompt, the hybrid CAG/RAG workflow 112 may remove ones of the knowledge items 128 that were also part of the knowledge items 118. The hybrid CAG/RAG workflow 112 may then submit the prompt with the integrated knowledge items 128 to the LLM 110 to answer the query 106. The result may then be provided as the answer 108.

FIG. 2 shows a hybrid CAG/RAG workflow for an AI that preloads a CAG context based on most frequent queries received by the AI, determines if a query is included among the most frequent queries, utilizes a CAG technique when the query is among the most frequent queries, and utilizes a RAG technique when the query is not among the most frequent queries. In FIG. 2, the predefined relevance criteria 122 are the most frequent queries 202 received by the AI 102 or by a group of AIs. Further, in the examples shown in FIG. 2, the most frequent queries 202 are used not only for managing the CAG context 120; rather, they are also used by the hybrid CAG/RAG workflow 112 in selecting between the CA G technique 116 and the RAG technique 126, performing one or the other based on whether the query 106 is in the most frequent queries 202. When the query 106 is among the most frequent queries 202, there is a substantial likelihood that the knowledge items 204 may be relevant, and the hybrid CAG/RAG workflow 112 may, at 206, utilize the CAG technique 116. When the query 106 is not among the most frequent queries 202, the hybrid CAG/RAG workflow 112 may, at 208, utilize the RAG technique 126 to retrieve knowledge items 210 from external source(s) 130.

The knowledge items 204 and 210 may be the same as knowledge items 118 and 128, or different. Different reference numerals are used in FIG. 2 for the knowledge items in recognition that a different or specific example criterion for the CAG context 120 is used in FIG. 1, the criterion is the predefined relevance criteria 122, while in FIG. 2, the criterion is most frequent queries 202, which may be an example of the predefined relevance criteria 122 or different from the predefined relevance criteria 122. Accordingly the knowledge items 204, which are determined by the most frequent queries 202, may be the same as or different from the knowledge items 118 (which are determined by the predefined relevance criteria 122). Additionally, FIG. 2 shows knowledge items 204 as knowledge items 204a, 204b, and 204c simply to indicate that the knowledge items 204 may comprise multiple, different items of information. FIG. 2 shows knowledge items 210 as knowledge items 210a, 210b, and 210c simply to indicate that the knowledge items 210 may comprise multiple, different items of information.

In various implementations, the hybrid CAG/RAG workflow 112 may determine the knowledge items 204 based on the most frequent queries 202. The most frequent queries 202 may be maintained in a list or any other structure, with that list or other structure also maintaining use statistics for the most frequent queries 202. The knowledge items 204 determined based on the most frequent queries 202 may be information relevant to answering those queries 202.

The hybrid CA G/RAG workflow 112 may also update the knowledge items 204 on a periodic or event drive basis. Such updating may rely on tracking the most frequent queries 202 and use statistics for those most frequent queries 202. Use statistics may be totals, rates, etc.—anything that can be used to evaluate any one query in view of other queries and judge it as more frequently received or less frequently received. In some implementations, if there have been no changes to the most frequent queries 202 (at least no changes to which queries it contains), the hybrid CAG/RAG workflow 112 may forgo an update if the updates are being done on a periodic basis. In other implementations, the hybrid CAG/RAG workflow 112 may trigger an update to the knowledge items 204 whenever a query is added to or removed from the most frequent queries 202.

In some examples, the hybrid CAG/RAG workflow 112 may process the knowledge items 204 to generate a key-value cache for the knowledge items 204 and may preload the key-value cache for the knowledge items 204 into the CAG context 120.

The hybrid CAG/RAG workflow 112 may be invoked for each received query 106 or may be invoked on a case-by-case basis by the AI 102 based on needs of the LLM 110. For example, the AI 102 may first attempt to answer the query 106 without reference to information from the hybrid CAG/RAG workflow 112 and, if the answer produced by the LLM 110 does not meet a success criterion, the AI 102 may invoke the hybrid CAG/RAG workflow 112. Alternatively, the AI 102 may apply some criterion in determining whether to invoke the hybrid CAG/RAG workflow 112 or simply proceed without doing so.

In some implementations, when the hybrid CAG/RAG workflow 112 is invoked by the AI 102, the hybrid CAG/RAG workflow 112 may determine whether the query 106 is included among the most frequent queries 202. When the query 106 is included among the most frequent queries, the hybrid CAG/RAG workflow 112, at 206, utilizes a CAG technique 116. The CAG technique 116 may include retrieving some or all of the knowledge items 204 from the CAG context 120 and integrating the retrieved knowledge items 204 with the prompt derived from the query 106 for processing by the AI 102. Such processing may include submitting the prompt with the integrated knowledge items 204 to the LLM 110 to answer the query 106. The result may then be provided as the answer 108.

When the query 106 is not included among the most frequent queries 202, however, the hybrid CAG/RAG workflow 112 may, at 208, utilize a RAG technique 126. The RAG technique 126 may include retrieving knowledge items 210 from external sources 130 and integrating the retrieved knowledge items 210 with the prompt derived from the query 106 for processing by the AI 102. In some examples, before integrating the knowledge items 210 with the prompt, the hybrid CAG/RAG workflow 112 may remove ones of the knowledge items 210 that were also part of the knowledge items 204. The hybrid CAG/RAG workflow 112 may then submit the prompt with the integrated knowledge items 210 to the LLM 110 to answer the query 106. The result may then be provided as the answer 108.

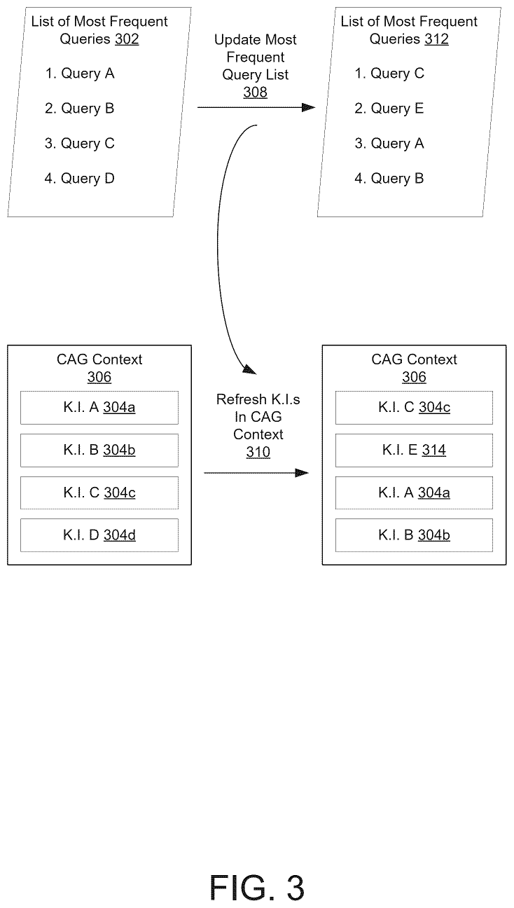

FIG. 3 shows an update to the most frequent queries received by an AI and a corresponding refresh of the knowledge items stored in a CAG context, the knowledge items being information relevant to answering the most frequent queries. As illustrated, a list of most frequent queries 302—which may be an example of most frequent queries 202 or predefined relevance criteria 122—may correspond to information relevant to answer those queries in the list 302, and the information may be represented by knowledge items 304a, 304b, 304c, and 304d. In FIG. 3, each knowledge item 304 corresponds to a query in the list of queries 302, and the knowledge items 304 are stored in a CAG context 306. The CAG context 306 may be an example of CAG context 120, and the knowledge items 304 may be examples of the knowledge items 204 or 118.

At a point in time, there may be an update 308 to the list of most frequent queries 302, and that update 308 may result in the hybrid CAG/RAG workflow 112 refreshing, at 310, the knowledge items stored in the CAG context 306. The updated list of most frequent queries 312 includes a new query, omits one of the queries from list 302, and has some of the queries from list 302 in a different order. The knowledge items stored in the CAG context 306 reflect the refresh 310—there is a new knowledge item, knowledge item 314, and knowledge item 304d has been removed.

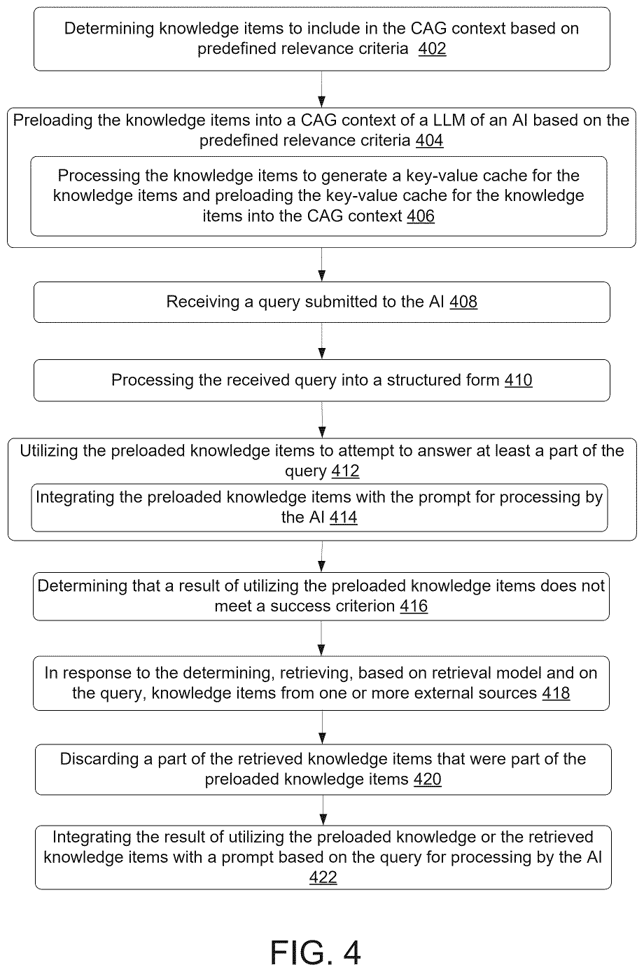

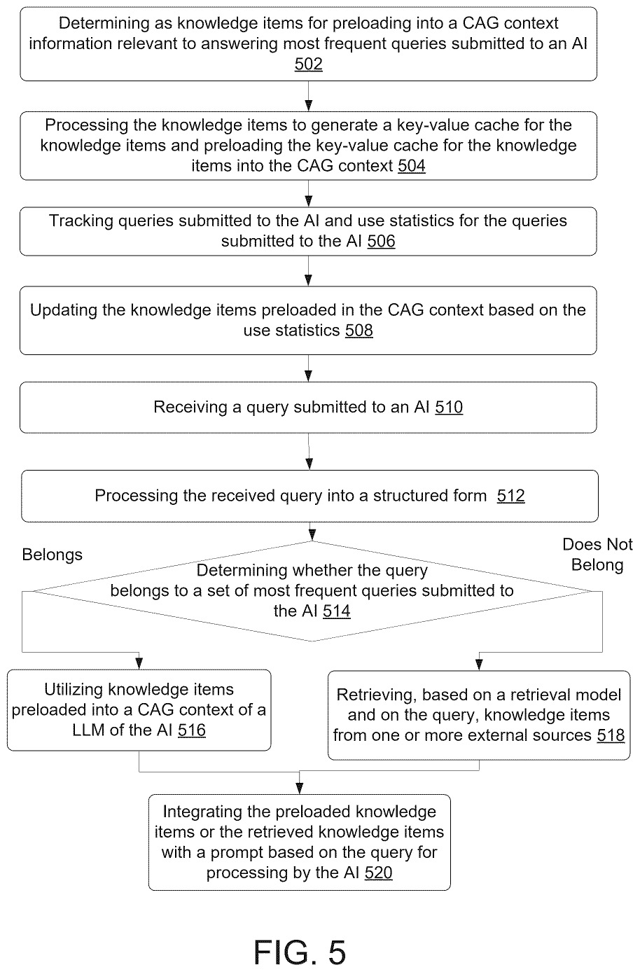

FIGS. 4 and 5 illustrate example processes. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be omitted or combined in any order and/or in parallel to implement the processes. The example processes shown in FIGS. 4 and 5 may be performed by components and devices such as those shown and described with respect to FIG. 6.

FIG. 4 shows a flowchart of an example process for preloading a CAG context based on predefined relevance criteria, attempting to answer a query using a CAG technique, and falling back to a RAG technique when the result of the CAG technique does not meet a success criterion.

At 402, computing device(s) implementing a hybrid CAG/RAG workflow may determine knowledge items to include in a CAG context of an LLM of an AI based on predefined relevance criteria.

At 404, the computing device(s) may preload the knowledge items into the CAG context. At 406, the preloading may include processing the knowledge items to generate a key-value cache for the knowledge items and preloading the key-value cache for the knowledge items into the CAG context.

At 408, the computing device(s) may receive a query submitted to the AI.

At 410, the computing device(s) may process the received query into a structured form.

At 412, the computing device(s) may utilize the preloaded knowledge items to attempt to answer at least a part of the query. At 414, the utilizing may include integrating the preloaded knowledge items with the prompt for processing by the AI.

At 416, the computing device(s) may determine that a result of utilizing the preloaded knowledge items does not meet a success criterion.

At 418, in response to the determining, the computing device(s) may retrieve, based on a retrieval model and on the query, knowledge items from one or more external sources.

At 420, the computing device(s) may discard a part of the retrieved knowledge items that were part of the preloaded knowledge items.

At 422, the computing device(s) may integrate the result of utilizing the preloaded knowledge or the retrieved knowledge items with a prompt based on the query for processing by the AI.

FIG. 5 shows a flowchart of an example process for preloading a CAG context based on most frequent queries received by the AI, determining if a query is included among the most frequent queries, utilizing a CAG technique when the query is among the most frequent queries, and utilizing a RAG technique when the query is not among the most frequent queries.

At 502, computing device(s) implementing a hybrid CAG/RAG workflow may determine as knowledge items for preloading into a CAG context of an LLM of an AI information relevant to answering most frequent queries submitted to an AI.

At 504, the computing device(s) may process the knowledge items to generate a key-value cache for the knowledge items and preload the key-value cache for the knowledge items into the CAG context.

At 506, the computing device(s) may track queries submitted to the AI and use statistics for the queries submitted to the AI.

At 508, the computing device(s) may update the knowledge items preloaded in the CAG context based on the use statistics.

At 510, the computing device(s) may receive a query submitted to an AI.

At 512, the computing device(s) may process the received query into a structured form.

At 514, the computing device(s) may determine whether the query belongs to a set of most frequent queries submitted to the AI.

At 516, when the query belongs to the set of most frequent queries, the computing device(s) may utilize knowledge items preloaded into a CAG context.

At 518, when the query does not belong to the set of most frequent queries, the computing device(s) may retrieve, based on a retrieval model and on the query, knowledge items from one or more external sources.

At 520, the computing device(s) may integrate the preloaded knowledge items or the retrieved knowledge items with a prompt based on the query for processing by the AI.

FIG. 6 shows an example system architecture for a computing device that is capable of implementing the hybrid CAG/RAG workflow for an AI. The computing device 600 may include one or more computers, servers, mobile computing devices, or other types of computing devices that may execute one or more elements described herein. Additionally or alternatively, the computing device 600 may include virtual machine(s) operating on physical computing device(s), with the components and functionality of the computing device 600 distributed among one or more virtual machines, one or more physical computing devices, or a combination of both. As noted, the computing device 600 may implement either or both of the hybrid CAG/RAG workflows shown in FIGS. 1 and 2 and described further herein. Additionally, the computing device 600 may perform any or all of the operations shown in FIGS. 4 and 5 and described further herein.

The computing device 600 may include memory 602. In various examples, the memory 602 may include system memory, which may be volatile (such as RAM) , non-volatile (such as ROM, flash memory, non-volatile memory express (NVMe), etc.) or some combination of the two. The memory 602 may further include non-transitory computer storage media, such as volatile and nonvolatile, removable and non-removable media implemented in any method or technology for storage of information, such as computer readable instructions, data structures, program modules, or other data. System memory, removable storage, and non-removable storage are all examples of non-transitory computer storage media. Examples of non-transitory computer storage media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which may be used to store desired information and which may be accessed by the computing device 600. Any such non-transitory computer storage media may be part of the computing device 600.

The memory 602 can include one or more software or firmware elements, such as computer-readable instructions that are executable by one or more processors. For example, the memory 602 can store computer-executable instructions associated with modules and data 604. The modules and data 604 can include a platform, operating system, applications, and data utilized by the platform, operating system, and applications. Further, the modules and data 604 can implement any of the functionality for the devices and components described and illustrated herein.

The computing device 600 may also have one or more processors 606. In various examples, each of the processors 606 may be a central processing unit (CPU), a graphics processing unit (GPU), both a CPU and a GPU, or any other type of processing unit. Each of the one or more processors 606 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processors 606 may also be responsible for executing computer applications stored in the memory 602, which may be associated with types of volatile and/or nonvolatile memory. For example, the processors 606 may access data and computer-executable instructions stored in the memory 602 and execute such computer-executable instructions.

The computing device 600 may also have one or more transceivers 608. The transceivers 608 may include modems, interfaces, antennas, telephone connections, and/or other components that may transmit and/or receive data over networks, telephone lines, or other connections, or that may transfer data to or from removable storage media or other elements connected to the transceivers 608.

In some examples, the computing device 600 may also have one or more input/output devices 610, such as a keyboard, a mouse, a touch-sensitive display, voice input device, a display, speakers, a printer, etc. These devices are well known in the art and need not be discussed at length here.

Although the subject matter has been described in language specific to structural features and/or methodological acts, it is to be understood that the subject matter is not necessarily limited to the specific features or acts described above. Rather, the specific features and acts described above are disclosed as example embodiments.

1. A hybrid cache-augmented generation (CAG)/retrieval-augmented generation (RAG) system comprising:
one or more processors; and
a workflow component configured to be operated by the one or more processors to perform operations including:
preloading knowledge items into a CAG context of a large language model (LLM) of an artificial intelligence (AI) based on predefined relevance criteria;
receiving a query submitted to the AI;
utilizing the preloaded knowledge items of the CAG context to attempt to answer at least a part of the query;
determining that a result of utilizing the preloaded knowledge items of the CAG context does not meet a success criterion;
in response to the determining, retrieving, based on a retrieval model and on the query, knowledge items from one or more external sources; and
integrating, for processing by the AI, the result of utilizing the preloaded knowledge or the retrieved knowledge items with a prompt based on the query.

2. The hybrid CAG/RAG system of claim 1, wherein the predefined relevance criteria include most frequent queries submitted to the AI.

3. The hybrid CAG/RAG system of claim 2, wherein the operations further include determining knowledge items to include in the CAG context based on the most frequent queries received, wherein determined knowledge items are information relevant to answering the queries.

4. The hybrid CAG/RAG system of claim 2, wherein the operations further include tracking queries submitted to the AI and use statistics for the queries submitted to the AI.

5. The hybrid CAG/RAG system of claim 4, wherein the operations further include updating the knowledge items preloaded in the CAG context based on the use statistics.

6. The hybrid CAG/RAG system of claim 1, wherein the preloading comprises processing the knowledge items to generate a key-value cache for the knowledge items and preloading the key-value cache for the knowledge items into the CAG context.

7. The hybrid CAG/RAG system of claim 1, wherein the operations further include processing the received query into a structured form that is then used in the utilizing, the retrieving, and the integrating.

8. The hybrid CAG/RAG system of claim 1, wherein the utilizing the preloaded knowledge items comprises integrating the preloaded knowledge items with the prompt for processing by the AI.

9. The hybrid CAG/RAG system of claim 1, wherein the operations further include discarding a part of the retrieved knowledge items that were part of the preloaded knowledge items.

10. A method implementing a hybrid cache-augmented generation (CAG)/retrieval-augmented generation (RAG) workflow, comprising:
receiving, by one or more computing devices, a query submitted to an artificial intelligence (AI);
determining, by the one or more computing devices, whether the query belongs to a set of most frequent queries submitted to the AI;
when the query belongs to the set of most frequent queries, utilizing, by the one or more computing devices, knowledge items preloaded into a CAG context of a large language model (LLM) of the AI;
when the query does not belong to the set of most frequent queries, retrieving, by the one or more computing devices and based on a retrieval model and on the query, knowledge items from one or more external sources; and
integrating, by the one or more computing devices, the preloaded knowledge items or the retrieved knowledge items with a prompt based on the query for processing by the AI.

11. The method of claim 10, wherein the knowledge items preloaded into the CAG context of the LLM are information relevant to answering the set of most frequent queries submitted to the AI.

12. The method of claim 11, further comprising tracking queries submitted to the AI and use statistics for the queries submitted to the AI.

13. The method of claim 12, further comprising updating the knowledge items preloaded in the CAG context based on the use statistics.

14. The method of claim 10, further comprising processing the received query into a structured form that is then used in the determining, the utilizing, the retrieving, and the integrating.

15. The method of claim 10, further comprising processing the knowledge items to generate a key-value cache for the knowledge items and preloading the key-value cache for the knowledge items into the CAG context.

16. A non-transitory computer storage medium having programming instructions stored thereon that, when executed by one or more processors, implement a hybrid cache-augmented generation (CAG)/retrieval-augmented generation (RAG) workflow, the hybrid CAG/RAG workflow including operations comprising:
receiving a query for an artificial intelligence (AI);
utilizing a CAG technique of the hybrid CAG/RAG workflow to attempt to answer the query based on a CAG context of a large language model (LLM) of the AI; and
based on the CAG technique not successfully answering the query, utilizing a RAG technique of the hybrid CAG/RAG workflow to retrieve information relevant to answering the query from an external source.

17. The non-transitory computer storage medium of claim 16, wherein the operations further comprise integrating the information retrieved from the external source with a prompt based on the query for processing by the AI.

18. The non-transitory computer storage medium of claim 17, wherein the utilizing the CAG technique comprises integrating information from the CAG context with the prompt for processing by the AI.

19. The non-transitory computer storage medium of claim 18, wherein the operations further comprise determining that a result of utilizing the CAG technique to attempt to answer the query does not meet a success criterion.

20. The non-transitory computer storage medium of claim 16, wherein the CAG context is preloaded with information based on predefined relevance criteria.
